(19) United States
(12) Patent Application Publication
(10) Pub. No.: US 2018/0159411 A1
(43) Pub. Date: Jun. 7, 2018

(54) RESOLVER MOUNTING STRUCTURE OF MOTOR

(71) Applicants: Hyundai Motor Company, Seoul (KR); Kia Motors Corporation, Seoul (KR)

(72) Inventors: Sangmo RYU, Busan (KR); Dongyeon HAN, Seoul (KR)

(73) Assignees: Hyundai Motor Company, Seoul (KR); Kia Motors Corporation, Seoul (KR)

(21) Appl. No.: 15/826,174

(22) Filed: Nov. 29, 2017

(30) Foreign Application Priority Data
Dec. 2, 2016 (KR) 10-2016-0163637

(51) Int. Cl. H02K 24/00; H02K 11/21; H02K 7/00; H02K 7/08

(52) U.S. Cl. CPC H02K 24/00; H02K 7/083; H02K 7/003; H02K 11/21

(57) ABSTRACT

A resolver mounting structure of a motor may include a resolver stator and a resolver rotor in the motor includes a front bearing including an external race coupled to a front cover of a motor housing and an internal race coupled to one side end portion of a rotation shaft, and a rear bearing including an external race coupled to a rear cover of the motor housing and an internal race coupled to the other side end portion of the rotation shaft, wherein the resolver stator is coupled to the front cover and is configured as a bearing cover for supporting the external race of the front bearing.

### CROSS-REFERENCE TO RELATED APPLICATION

The present application claims priority to Korean Patent Application No. 10-2016-0163637 filed on Dec. 2, 2016, the entire contents of which is incorporated herein for all purposes by this reference.

### BACKGROUND OF THE INVENTION

### Field of the Invention

The present invention relates to a motor of an electric powered vehicle, and more particularly, to a resolver mounting structure of a motor, for mounting a resolver for detecting rotation speed and rotation angle of the motor on a cover of a motor housing.

### Description of Related Art

Recently, all electric power environmentally-friendly vehicles such as an electric vehicle or a fuel cell vehicle have attracted attention. Such an electric power environmentally-friendly vehicle includes an electric motor (hereinafter, referred to as a drive motor) for driving a vehicle, installed therein to acquire torque via electrical energy, instead of an internal combustion engine such as a conventional engine.

A drive motor used as a power source of an environmentally-friendly vehicle includes a motor housing, a stator fixedly installed in the motor housing, and a rotor that faces the stator across a predetermined air gap and rotates around a rotation shaft as a driveshaft. Opposite ends of the rotor shaft are rotatably supported by covers (a front cover and a rear cover) of opposite sides of the motor housing through a bearing.

In general, with regard to a bearing employed in a drive motor of an environmentally-friendly vehicle, a bearing installed at a front cover side is configured as a fixed end bearing and a bearing installed at a rear cover side is configured as a free end bearing. Furthermore, the bearing includes an inner race fixed to a rotation shaft and an outer race installed at opposite cover side of the motor housing via press fit.

Here, the fixed end bearing includes a bearing cover for fixing the outer race to the front cover. The bearing cover restricts a degree of freedom in an axial direction of the fixed end bearing, supports the outer race of the fixed end bearing, and is engaged with the front cover through a bolt. Furthermore, the free end bearing includes the outer surface installed on the rear cover of the outer race via movable fit to achieve characteristics of absorbing assembly tolerance via free movement in an axial direction thereof.

The drive motor of the environmentally-friendly vehicle includes a position detector, such as a resolver, for detecting rotation speed and absolute position (rotation angle) of a rotor. A resolver as a position detector detects an absolute position of a motor rotor with an output signal with an AC low-voltage voltage (about 0.5 to 5 Vrms).

The resolver includes a resolver stator and a resolver rotor. The resolver rotor is fixed to a free end bearing side of a rotation shaft and the resolver stator is aligned and assembled with the resolver rotor and is fixed to the rear cover.

However, a drive motor configured for an environmentally-friendly vehicle needs to ensure a separate installation space because a bearing cover is installed on a front cover at a fixed end bearing side and a resolver is installed on a rear cover at a free end bearing side and, thus, an overall length of the drive motor is inevitably increased.

The information disclosed in the present Background of the Invention section is only for enhancement of understanding of the general background of the invention and may not be taken as an acknowledgement or any form of suggestion that the present information forms the prior art already known to a person skilled in the art.

### BRIEF SUMMARY

Various aspects of the present invention are directed to providing a resolver mounting structure of a motor having advantages of omitting a component including a bearing cover by mounting a resolver at a front cover side and configuring the resolver as a fixer for fixing an external race of a front bearing, reducing an overall length of the motor.

Various aspects of the present invention are directed to providing a resolver mounting structure of a motor, for mounting a resolver including a resolver stator and a resolver rotor in the motor, including a front bearing including an external race coupled to a front cover of a motor housing and an internal race coupled to one side end portion of a rotation shaft, and a rear bearing including an external race coupled to a rear cover of the motor housing and an internal race coupled to the other side end portion of the rotation shaft, wherein the resolver stator is coupled to the front cover and is configured as a bearing cover for supporting the external race of the front bearing.

The front bearing may be configured as a fixed end bearing.

The rear bearing may be configured as a free end bearing.

The resolver rotor may face the resolver stator across a predetermined air gap and may be fixed to one side end portion of the rotation shaft.

Various aspects of the present invention are directed to providing a resolver mounting structure of a motor, for mounting a resolver including a resolver stator and a resolver rotor in the motor, including a front bearing including an external race coupled to a front cover of a motor housing and an internal race coupled to one side end portion of a rotation shaft, and a rear bearing including an external race coupled to a rear cover of the motor housing and an internal race coupled to the other side end portion of the rotation shaft, wherein the resolver stator is shaped like a ring with a predetermined width, is coupled to the front cover via press fit, and is configured as a bearing cover for supporting the external race of the front bearing.

The resolver stator may include a press fit end portion fixed to the front cover via press fit and formed at an external edge end portion.

The front cover may include a press fit groove to which the press fit end portion of the resolver stator is fixed via press fit.

Various aspects of the present invention are directed to providing a resolver mounting structure of a motor, for mounting a resolver including a resolver stator and a resolver rotor in the motor, including a front bearing including an external race coupled to a front cover of a motor housing and an internal race coupled to one side end portion of a rotation shaft, and a rear bearing including an external race coupled to a rear cover of the motor housing and an internal race coupled to the other side end portion of the rotation shaft, wherein the resolver stator is shaped like a ring with a predetermined width, is coupled to the front cover through a bolt, and is configured as a bearing cover for supporting the external race of the front bearing.

The resolver stator may include bolt coupling holes to which the bolt is coupled and which are continuously spaced apart in a circumferential direction thereof.

The front cover may include a coupling groove for coupling the bolt coupled to the bolt coupling hole of the resolver stator.

According to an exemplary embodiment of the present invention, unlike in the related art in which the resolver stator of the resolver is coupled to a side of the rear cover, as the resolver stator is coupled to the front cover, an installation space of a resolver in the rear cover may be omitted and, thus, an overall length of the motor may be reduced

Furthermore, according to an exemplary embodiment of the present invention the resolver stator of the resolver may be coupled to the front cover and, as the resolver stator is fixed to an external race of the front bearing, the front bearing may be configured as the fixed end bearing through the resolver stator, and the resolver stator is disposed in the bearing cover for fixing the external race of the front bearing and, thus, a separate bearing cover like in the related art may be omitted, reducing manufacturing costs.

Other effects to be acquired or predicted according to an exemplary embodiment of the present invention will be indirectly or implicitly described in the following detailed description according to an exemplary embodiment of the present invention. That is, various effects predicted according to an exemplary embodiment of the present invention will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view showing a structure of a resolver mounting structure of a motor according to an exemplary embodiment of the present invention.

FIG. 2 is an enlarged view of a resolver mounting structure of a motor viewed from a front bearing side according to an exemplary embodiment of the present invention.

FIG. 3 is a diagram showing a stator of a resolver applied to a resolver mounting structure of a motor according to an exemplary embodiment of the present invention.

FIG. 4 is an enlarged view of a front bearing of a resolver mounting structure of a motor according to another exemplary embodiment of the present invention.

FIG. 5 is a diagram showing a stator of a resolver applied to a resolver mounting structure of a motor according to another exemplary embodiment of the present invention.

It may be understood that the appended drawings are not necessarily to scale, presenting a somewhat simplified representation of various features illustrative of the basic principles of the invention. The specific design features of the present invention as included herein, including, for example, specific dimensions, orientations, locations, and the shapes will be determined in part by the particularly intended application and use environment.

In the figures, reference numbers refer to the same or equivalent parts of the present invention throughout the several figures of the drawing.

### DETAILED DESCRIPTION

Reference will now be made more specifically to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the other hand, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present application will be described more fully with reference to the accompanying drawings, in which exemplary embodiments of the invention are shown. As those skilled in the art would realize, the described embodiments may be modified in various different ways, all without departing from the spirit or scope of the present invention.

To clearly describe the present invention, a part without concerning to the description is omitted in the drawings, and like reference numerals in the specification denote like elements.

Sizes and thicknesses of the elements shown in the drawings are for descriptive convenience, and thus the present invention is not necessarily limited thereto. Thicknesses of layers and regions are expanded in the drawings for clarity.

Throughout the specification, although the terms first, second, etc. may be used herein to describe various elements, these elements may not be limited by these terms.

Throughout this specification, when a certain part “includes” a certain component, this indicates that the part may further include another component instead of excluding another component unless there is no different disclosure

Furthermore, the terms “.unit”, “-er” , “-or” and “member” described in the specification signifies devices for processing at least one function and operation.

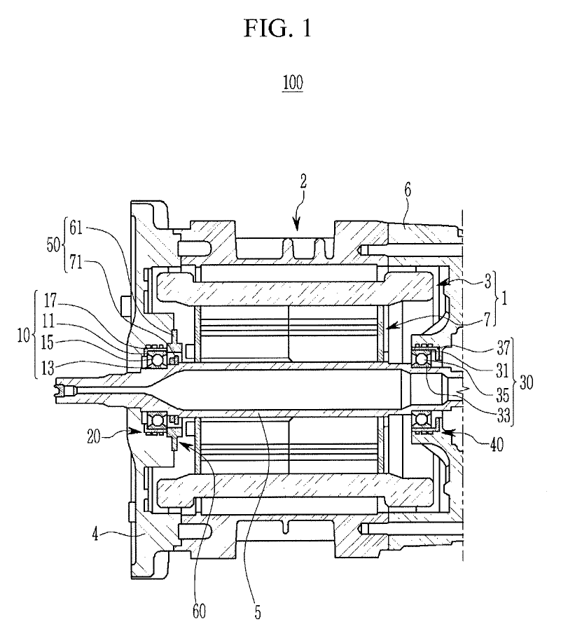

FIG. 1 is a cross-sectional view showing a structure of a resolver mounting structure of a motor according to an exemplary embodiment of the present invention.

Referring to FIG. 1, a motor resolver mounting structure 100 according to an exemplary embodiment of the present invention may be applied to a drive motor of an all electric power environmentally-friendly vehicle including an electric vehicle or a fuel cell vehicle or a drive motor of a hybrid environmentally-friendly vehicle using electric power and driving force of an engine.

For example, a drive motor 1 (hereinafter, referred to as a “motor” for convenience) applied to an exemplary embodiment of the present invention may include a permanent magnet synchronous motor (PMSM) or may include a wound rotor synchronous motor (WRSM).

The aforementioned motor 1 may include a motor housing 2, a stator 3 fixedly disposed in the motor housing 2, and a rotor 7 that faces the stator 3 across a predetermined air gap and rotates around a rotation shaft 5 as a driveshaft.

Here, the motor housing 2 may include a front cover 4 that seals a front side and a rear cover 6 that seals a rear side. With regard to the rotor 7, one side end portion of the rotation shaft 5 may be rotatably supported by the front cover 4 and the other side end portion of the rotation shaft 5 may be rotatably supported by the rear cover 6.

Furthermore, one side end portion of the rotation shaft 5 may be rotatably coupled to the front cover 4 through a front bearing 10 and the other side end portion of the rotation shaft 5 may be rotatably coupled to the rear cover 6 through a rear bearing 30.

According to an exemplary embodiment of the present invention, the front bearing 10 may include a first external race 11 coupled to the front cover 4, a first internal race 13 coupled to one side end portion of the rotation shaft 5, and a first rolling member 15 disposed between the first external race 11 and the first internal race 13.

The first external race 11 may be disposed on the front cover 4 through a first bearing bracket 17 via movable fit. The first internal race 13 may be disposed in the first external race 11 and may be fixedly disposed at one side end portion of the rotation shaft 5 via press fit using a sliding method. Furthermore, the first rolling member 15 may include a plurality of balls that roll along a race between the first internal race 13 and the first external race 11 through the first internal race 13 which is rotated by the rotation shaft 5.

According to an exemplary embodiment of the present invention, the rear bearing 30 may include a second external race 31 coupled to the rear cover 6, a second internal race 33 coupled to the other side end portion of the rotation shaft 5, and a second rolling member 35 disposed between the second external race 31 and the second internal race 33.

The second external race 31 may be disposed on the rear cover 6 through a second bearing bracket 37 via movable fit. The second internal race 33 may be disposed in the second external race 31 and may be fixedly disposed at the other side end portion of the rotation shaft 5 via press fit using a sliding method. Furthermore, the second rolling member 35 may include a plurality of balls that roll along a race between the second internal race 33 and the second external race 31 through the second internal race 33 which is rotated by the rotation shaft 5.

Here, the aforementioned first external race 11 of the front bearing 10 may be fixed to the front cover 4 through a separate fixer. The fixer may be fixed to the front cover 4, may support the first external race 11, and may restrict a degree of freedom in an axial direction of the first external race 11 with respect to the front cover 4. As the first external race 11 is fixed to the front cover 4 through the fixer, the aforementioned front bearing 10 may be configured as a fixed end bearing 20 according to an exemplary embodiment of the present invention. A detailed configuration and assembly structure of the fixer will be described below in more detail.

The aforementioned rear bearing 30 may not include a separate fixer like in the structure of the front bearing 10 and, as the second external race 31 is disposed on the rear cover 6 via movable fit, a degree of freedom in an axial direction of the second external race 31 with respect to the rear cover 6 may be allowed. Accordingly, the rear bearing 30 may not fix the second external race 31 through a separate fixer and, as the rear bearing 30 is disposed on the rear cover 6 via movable fit, characteristics of absorbing assembly tolerance may be achieved due to free movement in an axial direction thereof Accordingly, according to an exemplary embodiment of the present invention, the rear bearing 30 may be configured as the free end bearing 40.

According to an exemplary embodiment of the present invention, a resolver 50 as a position detector for detecting rotation speed and absolute position of the rotor 7 may be disposed at the aforementioned motor 1. The resolver 50 may include a resolver stator 61, a resolver rotor 71, and a rotation transformer.

According to an exemplary embodiment of the present invention, the motor resolver mounting structure 100 may include a fixer for mounting the resolver 50 at a side of the front cover 4 and fixing the resolver 50 to the first external race 11 of the front bearing 10 and, thus, a conventional component including a baring cover may be omitted to provide a structure of reducing an overall length of the motor 1.

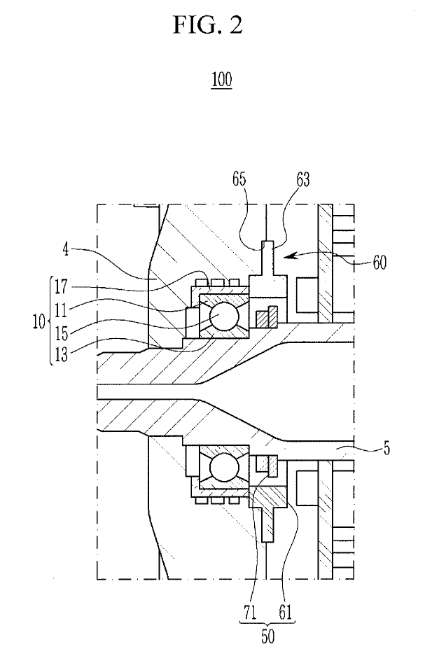

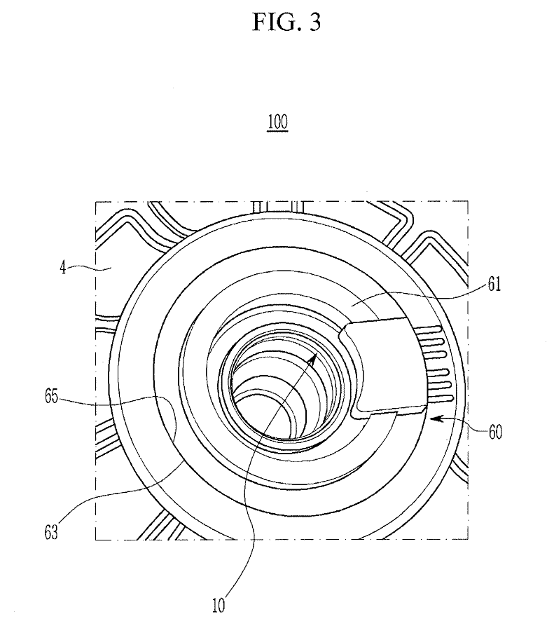

FIG. 2 is an enlarged view of a front bearing of a resolver mounting structure of a motor according to an exemplary embodiment of the present invention. FIG. 3 is a diagram showing a stator of a resolver applied to a resolver mounting structure of a motor according to an exemplary embodiment of the present invention. Here, FIG. 3 is a diagram showing the resolver stator 61 viewed in direction from an internal side of the motor housing 2.

Referring to FIG. 1, FIG. 2, and FIG. 3, the motor resolver mounting structure 100 according to an exemplary embodiment of the present invention may be configured such that the resolver stator 61 of the resolver 50 is coupled to the front cover 4 and is included as a bearing cover 60 for supporting the first external race 11 of the front bearing 10. Here, the “end” may be defined as an end portion of one side and may be defined as a predetermined portion including the end portion.

According to an exemplary embodiment of the present invention, the resolver stator 61 may be shaped like a ring (or a disk) with a predetermined width. The resolver stator 61 may form an external edge end portion and an internal edge end portion.

Here, the external edge end portion of the resolver stator 61 may be coupled to a side of the front bearing 10 of the front cover 4. The external edge end portion of the resolver stator 61 may be coupled to an internal side wall of the front cover 4 and may support and fix the first external race 11 of the front bearing 10. Furthermore, the external edge end portion of the resolver stator 61 may be coupled to an internal side wall of the front cover 4 and may support and fix the first bearing bracket 17 of the first external race 11.

Accordingly, the external edge end portion of the resolver stator 61 may be coupled to the front cover 4 and, as the first external race 11 of the front bearing 10 is supported and fixed, the resolver stator 61 may include a fixer for fixing the first external race 11 of the front bearing 10 and the bearing cover 60 like in the related art, according to an exemplary embodiment of the present invention.

The resolver rotor 71 of the resolver 50 may surface the resolver stator 61 across a predetermined air gap in the resolver stator 61 and may be aligned and assembled with the resolver stator 61 at one side end portion of the rotation shaft 5. The resolver rotor 71 may be fixedly disposed at one side end portion of the rotation shaft 5.

The remaining configuration of the aforementioned resolver stator 61 and resolver rotor 71 may be configured as a resolver assembly which is well-known to one of ordinary skill in the art and, thus, a detailed description of the configuration will be omitted in the specification.

According to an exemplary embodiment of the present invention, the resolver stator 61 may be coupled to the front cover 4 via press fit. That is, the external edge end portion of the resolver stator 61 may be fixed to an internal side wall of the front cover 4 via press fit.

To the present end, the resolver stator 61 may include a press fit end portion 63 fixed to the front cover 4 via press fit at an external edge end portion. Furthermore, a press fit groove 65 to which the press fit end portion 63 of the resolver stator 61 is fixed via press fit may be formed in an internal side wall of the front cover 4. For example, the press fit groove 65 may include a stumbling projection caught by the press fit end portion 63 of the resolver stator 61 to support the press fit end portion 63.

Accordingly, due to the motor resolver mounting structure 100 according to an exemplary embodiment of the present invention, the press fit end portion 63 of the resolver stator 61 may be coupled to the press fit groove 65 of the front cover 4 via press fit and may fix the first external race 11 of the front bearing 10 through the resolver stator 61.

Accordingly, according to an exemplary embodiment of the present invention, unlike in the related art in which the resolver stator 61 of the resolver 50 is coupled to a side of the rear cover 6, as the resolver stator 61 is coupled to the front cover 4, an installation space of a resolver in the rear cover 6 may be omitted and, thus, an overall length of the motor 1 may be reduced.

Furthermore, according to an exemplary embodiment of the present invention, the resolver stator 61 of the resolver 50 is coupled to the front cover 4 and, as the resolver stator 61 fixes the first external race 11 of the front bearing 10, the front bearing 10 may be configured as the fixed end bearing 20 through the resolver stator 61. Furthermore, according to an exemplary embodiment of the present invention, the resolver stator 61 is disposed in the bearing cover 60 for fixing the external race 11 of the front bearing 10 and, thus, a separate bearing cover like in the related art may be omitted, reducing manufacturing costs.

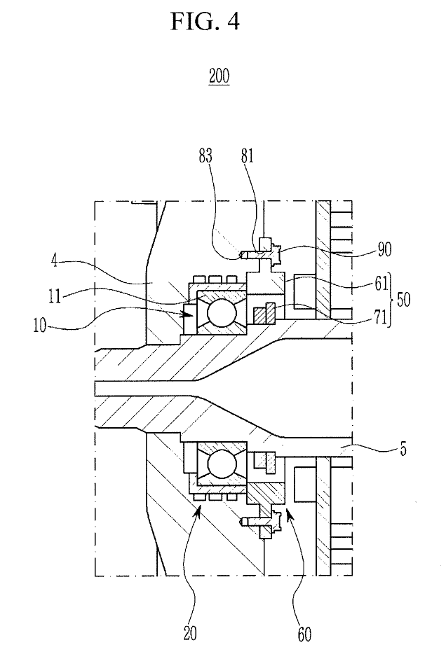

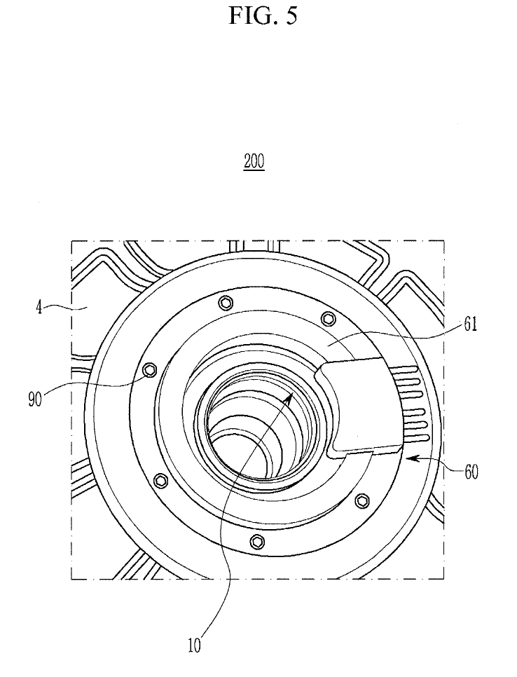

FIG. 4 is an enlarged view of a front bearing of a resolver mounting structure of a motor according to another exemplary embodiment of the present invention. FIG. 5 is a diagram showing a stator of a resolver applied to a resolver mounting structure of a motor according to another exemplary embodiment of the present invention. Here, FIG. 5 is a diagram showing the resolver stator 61 viewed in direction from an internal side of the motor housing. Like reference numerals in the above embodiments of the present invention denote like elements.

Referring to FIG. 4 and FIG. 5, a motor resolver mounting structure 200 according to another exemplary embodiment of the present invention may include the above structure according to the aforementioned exemplary embodiment as a basic structure and may include the resolver 50 configured by coupling the resolver stator 61 to the front cover 4 via a bolt. Like in the aforementioned exemplary embodiment of the present invention, the resolver 50 may include the resolver rotor 71 disposed on one side end portion of the rotation shaft 5.

According to an exemplary embodiment of the present invention, bolt coupling holes 81 to which a bolt 90 is coupled may be continuously distanced from each other in a circumferential direction in the external edge end portion of the resolver stator 61. Furthermore, coupling grooves 83 for coupling the bolt 90 coupled to the bolt coupling hole 81 of the resolver stator 61 may be formed in the internal side wall of the front cover 4.

Accordingly, in the motor resolver mounting structure 200 according to the above another exemplary embodiment of the present invention, the external edge end portion of the resolver stator 61 may be coupled to the internal side wall of the front cover 4 through the bolts 90 and may support and fix the first external race 11 of front bearing 10 through the resolver stator 61.

Accordingly, according to an exemplary embodiment of the present invention, the front bearing 10 may be configured as the fixed end bearing 20 through the resolver stator 61 and the resolver stator 61 may be configured as the bearing cover 60 for supporting and fixing the first external race 11 of the front bearing 10.

The remaining configuration and effects of the motor resolver mounting structure 200 according to the above another exemplary embodiment of the present invention are the same as or substantially the same as or substantially the same as or substantially the same as the above exemplary embodiment and, thus, a detailed description thereof will be omitted here.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A resolver mounting structure of a motor, for mounting a resolver including a resolver stator and a resolver rotor in the motor, comprising:
a front bearing including an external race coupled to a front cover of a motor housing and an internal race coupled to a first side end portion of a rotation shaft; and
a rear bearing including an external race coupled to a rear cover of the motor housing and an internal race coupled to a second side end portion of the rotation shaft,
wherein the resolver stator is coupled to the front cover and is configured as a bearing cover for supporting the external race of the front bearing.

2. The resolver mounting structure of the motor of claim 1, wherein
the front bearing is configured as a fixed end bearing.

3. The resolver mounting structure of the motor of claim 2, wherein
the rear bearing is configured as a free end bearing.

4. The resolver mounting structure of the motor of claim 1, wherein
the resolver rotor faces the resolver stator across a predetermined air gap and is fixed to the one side end portion of the rotation shaft.

5. A resolver mounting structure of a motor, for mounting a resolver including a resolver stator and a resolver rotor in the motor, comprising:
a front bearing including an external race coupled to a front cover of a motor housing and an internal race coupled to a first side end portion of a rotation shaft; and
a rear bearing including an external race coupled to a rear cover of the motor housing and an internal race coupled to a second side end portion of the rotation shaft,
wherein the resolver stator is shaped of a ring with a predetermined width, is coupled to the front cover via press fit, and is configured as a bearing cover for supporting the external race of the front bearing.

6. The resolver mounting structure of the motor of claim 5, wherein
the resolver stator includes a press fit end portion fixed to the front cover via press fit and formed at an external edge end portion.

7. The resolver mounting structure of the motor of claim 6, wherein
the front cover includes a press fit groove to which the press fit end portion of the resolver stator is fixed via press fit.

8. A resolver mounting structure of a motor, for mounting a resolver including a resolver stator and a resolver rotor in the motor, comprising:
a front bearing including an external race coupled to a front cover of a motor housing and an internal race coupled to a first side end portion of a rotation shaft; and
a rear bearing including an external race coupled to a rear cover of the motor housing and an internal race coupled to a second side end portion of the rotation shaft,
wherein the resolver stator is shaped of a ring with a predetermined width, is coupled to the front cover through a fastener, and is configured as a bearing cover for supporting the external race of the front bearing.

9. The resolver mounting structure of the motor of claim 8, wherein
the resolver stator includes fastener coupling holes to which the fastener is coupled and which are continuously spaced apart in a circumferential direction thereof.

10. The resolver mounting structure of the motor of claim 9, wherein
the front cover includes a coupling groove for coupling the fastener coupled to the fastener coupling holes of the resolver stator.
